(19) United States
(12) Patent Application Publication
(10) Pub. No.: US 2026/0026653 A1
(43) Pub. Date: Jan. 29, 2026

(54) MULTI-STEP ADJUSTABLE HEAD TILTING MECHANISM FOR TILT-HEAD MIXER

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/787,134

(22) Filed: Jul. 29, 2024

(51) Int. Cl. A47J 43/07; A47J 43/044

(52) U.S. Cl. CPC A47J 43/0705; A47J 43/044; A47J 2043/04481

(57) ABSTRACT

A stand mixer may include a casing having a base and a column extending from the base. The casing may define an interior surface directed toward an interior cavity and an exterior surface directed away from the interior cavity. The stand mixer may include a tilting head pivotable between a closed position and a first opened position and further pivotable between the first opened position and a second opened position, wherein an angle of the second opened position is greater than an angle of the first opened position. The stand mixer may also include a spring in biased engagement with the tilting head to bias the tilting head to the first opened position. The stand mixer may further include a friction pin in selective engagement with the tilting head to hold the tilting head at a variable position between the first opened position and the second opened position.

### FIELD OF THE DISCLOSURE

The present subject matter relates generally to kitchen appliances, and more particularly to stand mixer appliances.

### BACKGROUND OF THE DISCLOSURE

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. The motor may be provided in a tilting head attached to a base via a stand column. The tilting head may be adjusted to an open position in order to adjust the position of the utensil or in order for a user to more easily access an area in close proximity to the utensil. For convenience, the tilting head may adjust around a pivot point between the stand column and the tilting head.

Although it may be desirable to tilt the tilting head to an open position, current embodiments of tilt-head stand mixers present challenges. For instance, a tilt angle between a closed position and the opened position may be more desirable for a certain function of the stand mixer. Furthermore, certain preset angle options may also not be adequate for the stand mixer to perform said function (e.g., churning, mixing, cleaning, storage, etc.). Thus, a preset angle may be considered as too closed or too open for a user. In certain embodiments that adopt preset angles, the tilt head may be adjustable to a specific angle, but is unable to be held at the precise position.

As a result, further improvements may be useful, such as to ensure that a precise tilting head angle is adequate and may be maintained for a certain functionality of the stand mixer.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a stand mixer is provided. The stand mixer may include a casing, a tilting head, a spring, and a friction pin. The casing may comprise a base and a column extending from the base along a vertical direction, the casing defining an interior surface directed toward an interior cavity and an exterior surface directed away from the interior cavity. The tilting head may be positioned on top of the column and may be pivotable between a closed position and a first opened position. The tilting head may further be pivotable between the first opened position and a second opened position. The angle of the second opened position relative to a horizontal direction may be greater than an angle of the first opened position relative to the horizontal direction. The spring may be attached to the casing in biased engagement with the tilting head. The spring may also bias the tilting head to the first opened position from the closed position. The friction pin may be mounted on the column in selective friction engagement with the tilting head. The friction pin may also hold the tilting head at a variable position between the first opened position and the second opened position.

In another exemplary aspect of the present disclosure, another stand mixer is provided. The stand mixer may include a casing, a tilting head, a spring, a friction pin, a button, a tiltable latch, and a catch surface. The casing may comprise a base and a column extending from the base along a vertical direction, the casing defining an interior surface directed toward an interior cavity and an exterior surface directed away from the interior cavity. The tilting head may be positioned on top of the column and may be pivotable between a closed position and a first opened position. The tilting head may further be pivotable between the first opened position and a second opened position. The angle of the second opened position relative to a horizontal direction may be greater than an angle of the first opened position relative to the horizontal direction. The spring may be attached to the casing in biased engagement with the tilting head. The spring may also bias the tilting head to the first opened position from the closed position. The friction pin may be mounted on the column in selective friction engagement with the tilting head. The friction pin may also hold the tilting head at a variable position between the first opened position and the second opened position. The friction pin may further be received within a guide track defined along a pivot path of the tilting head. The button may be mounted to the tilting head. The tiltable latch may be coupled to the button. The catch surface may be attached to the casing and the tiltable latch may be in selective engagement with the catch surface to hold the tilting head in the closed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to exemplary embodiments of the present disclosure.

FIG. 2 provides a perspective view of the exemplary stand mixer of FIG. 1 with a column cover removed.

FIG. 3A provides a perspective view of a locking mechanism for a stand mixer according to exemplary embodiments of the present disclosure, wherein the locking mechanism is in a locked position.

FIG. 3B provides a perspective view of a locking mechanism for a stand mixer according to exemplary embodiments of the present disclosure, wherein the locking mechanism is in an unlocked position.

FIG. 4 provides an overhead perspective view of the locking mechanism of FIGS. 3A and 3B according to exemplary embodiments of the present disclosure.

FIG. 5 provides a side perspective view of the stand mixer, wherein a tilting head is pivoted to a first opened position.

FIG. 6 provides a side perspective view of a portion of the stand mixer of FIG. 5 according to exemplary embodiments of the present disclosure.

FIG. 7 provides a perspective view of the tilting capabilities of the tilting head according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The phrase “in one embodiment,” does not necessarily refer to the same embodiment, although it may. The terms “first,” “second,” and “third” may be used interchangeably to distinguish one component from another and are not intended to signify location or importance of the individual components.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

Due to current embodiments of tilting head mixers, there are restrictions on angles that the tilting head can be positioned at, such that current embodiments often utilize preset angle options. The lack of angle options may be due to preset angle options for tilting head mixers that allow a plurality of angle options, however a user may still be restricted from selecting an exact angle needed for a function. Further, current embodiments may lack an apparatus for holding the tilting head at an exact angle selected by the user.

The present disclosure remedies these setbacks via a stand mixer comprising a multi-step tilting mechanism that utilizes a frictional stopper in order to select and maintain a preferred angle of tilt. The multistep tilting mechanism may comprise three steps. Any combination of the three steps may be used in order to create multiple working embodiments of the present disclosure.

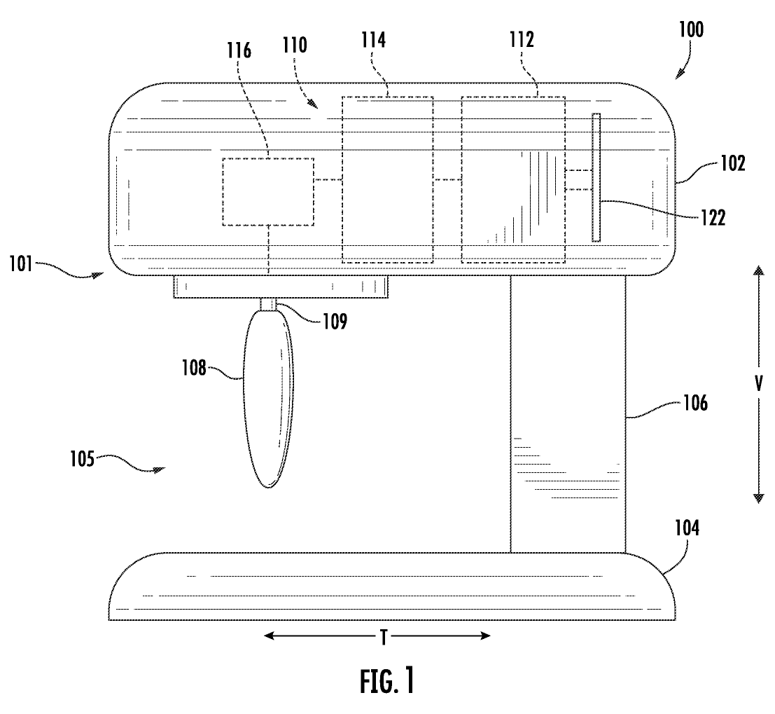

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical or electrical components of stand mixer 100, which will be described in further detail below. For example, as shown in FIG. 1, a motor 112, a planetary or reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed or mounted to base 104.

As will be described in later detail below, motor housing 102 may be pivotable (e.g., tilted) to a plurality of positions around a pivot point. The pivot point may be a connection between a rear end of motor housing 102 and column 106, such that motor housing 102 and column 106 are coupled together. Motor housing 102 may be pivotable from a closed position. Motor housing 102 may first be pivotable to a first opened position. Motor housing 102 may also be pivotable to a second opened position.

A drivetrain 110 may be provided within motor housing 102 and is configured for coupling motor 112 to a shaft 109 (e.g., a mixer shaft), such that shaft 109 is rotatable via motor 112 through drivetrain 110. Drivetrain 110 may include planetary gearbox 114, bevel gearbox 116, etc. An opening 132 for a horizontal accessory shaft 130 may align with the rotational axis of motor 112. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102. The rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

Stand mixer 100 may include a controller 122 provided within casing 101. For example, controller 122 may be located within motor housing 102 of casing 101. Controller 122 may be a microcontroller, as would be understood, including one or more processing devices, memory devices, or controllers. Controller 122 may include a plurality of electrical components configured to permit operation of stand mixer 100 and various components therein (e.g., motor 112). For instance, controller 122 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 122 may be constructed without using a microprocessor, e.g., using a combination of discrete analog or digital logic circuitry (such as switches, amplifiers, integrators, comparators, flip-flops, gates, and the like) to perform control functionality instead of relying upon software.

Controller 122 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information or data accessible by the one or more processors, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

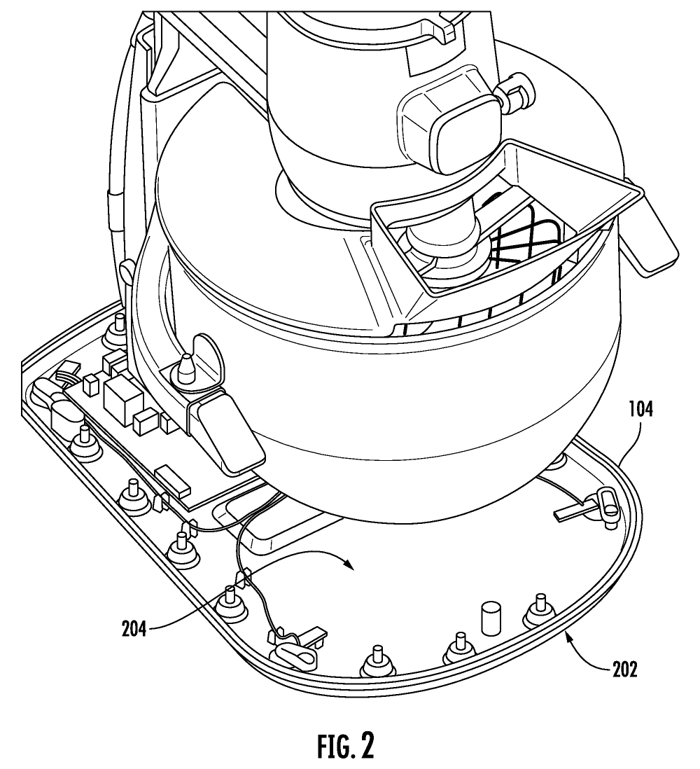

FIG. 2 provides an interior view of base 104 of stand mixer 100. In FIG. 2, a cover (e.g., covering base 104, column 106, or each of base 104 and column 106) is removed for the sake of clarity. Casing 101 may define an interior cavity 206. For instance, interior cavity 206 may be formed within each of base 104, column 106, and motor housing 102. A plurality of components (e.g., electrical components, mechanical components, control components, etc.) may be provided within interior cavity 206. For instance, casing 101 may define an exterior surface 202 and an interior surface 204. Interior surface 204 may be directed toward interior cavity 206 of casing 101 while exterior surface 202 is directed away from the interior cavity 206. One or more components may be selectively fixed or attached to interior surface 204 (e.g., of base 104 or column 106).

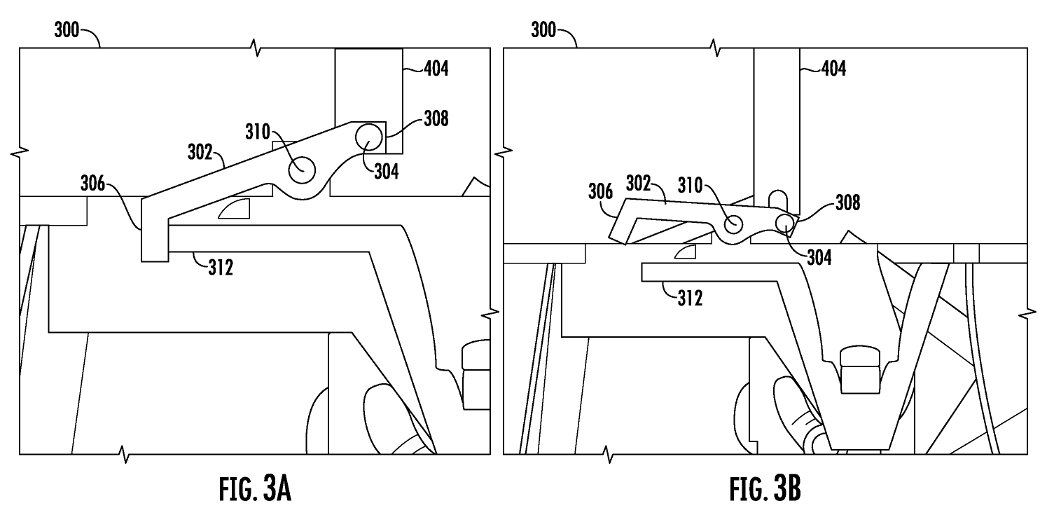

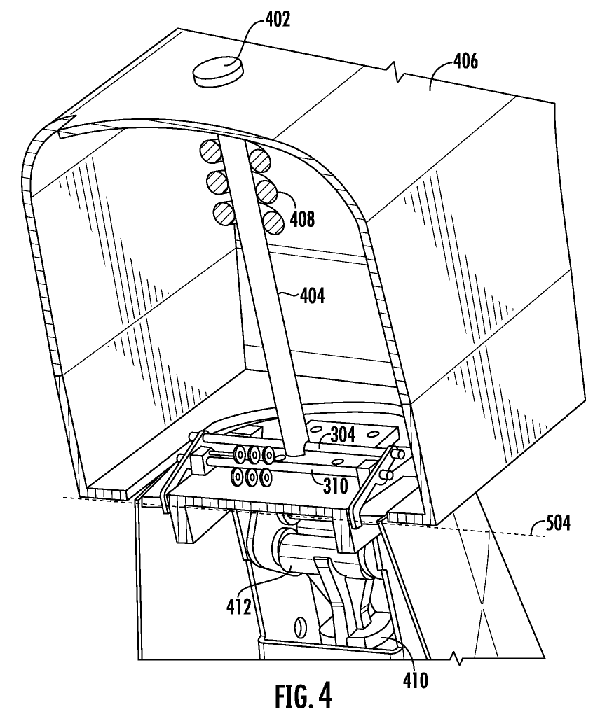

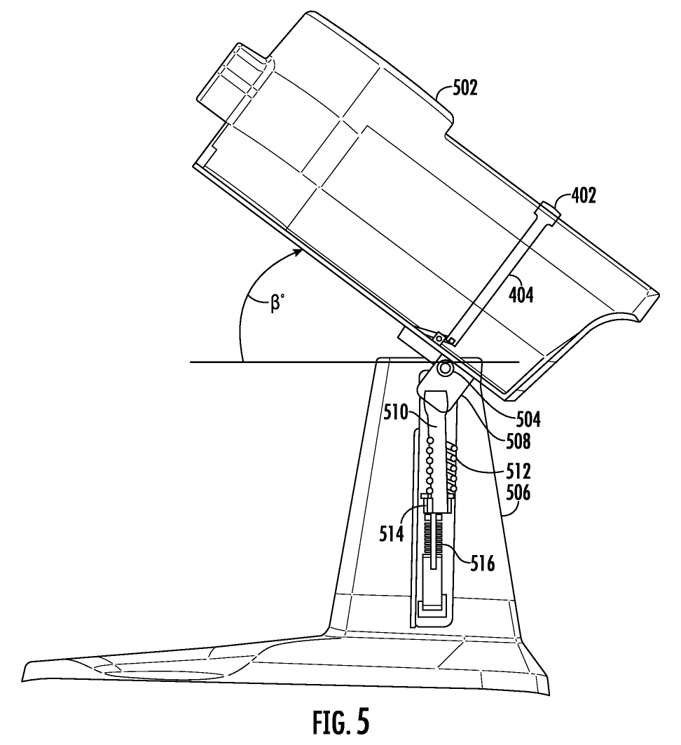

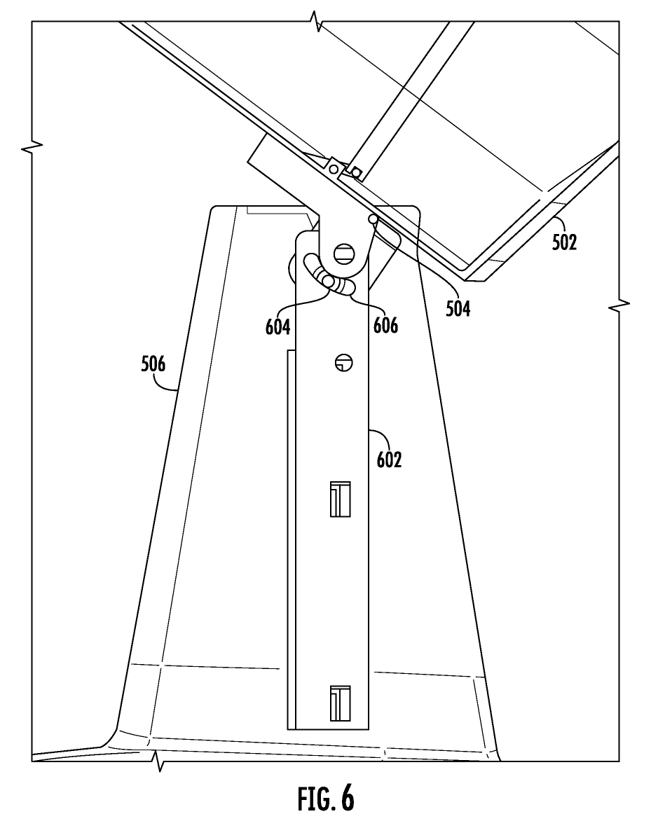

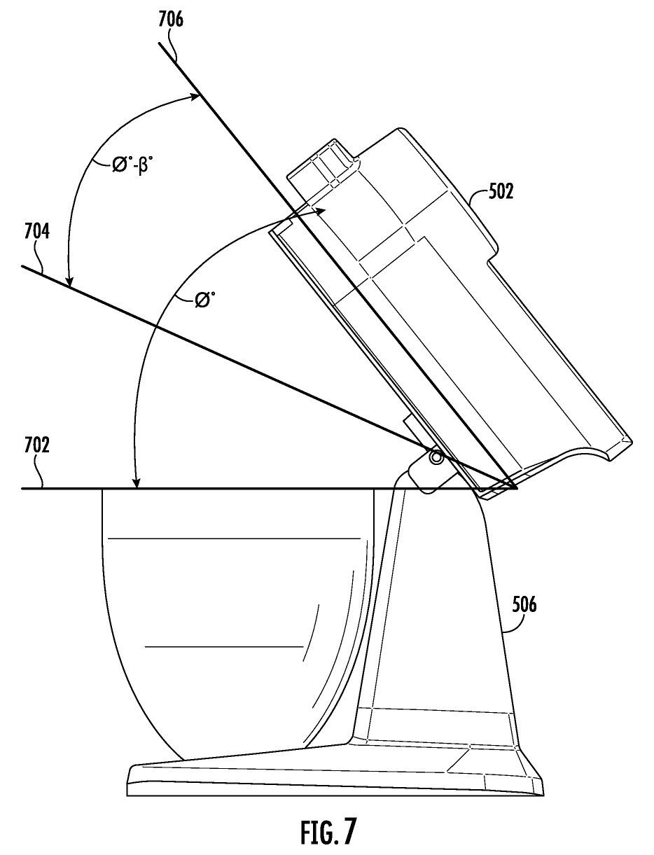

Turning now generally to FIGS. 3A through 7, FIG. 3A provides a perspective view of a locking mechanism for a stand mixer according to exemplary embodiments of the present disclosure, wherein the locking mechanism is in a locked position. FIG. 3B provides a perspective view of a locking mechanism for a stand mixer according to exemplary embodiments of the present disclosure, wherein the locking mechanism is in an unlocked position. FIG. 4 provides an overhead perspective view of the locking mechanism of FIGS. 3A and 3B according to exemplary embodiments of the present disclosure. FIG. 5 provides a side perspective view of the stand mixer, wherein a tilting head is pivoted to a first opened position. FIG. 6 provides a side perspective view of a portion of the stand mixer of FIG. 5 according to exemplary embodiments of the present disclosure. FIG. 7 provides a perspective view of the tilting capabilities of the tilting head according to exemplary embodiments of the present disclosure.

A tilting head 502 (e.g., including motor housing 102 —FIGS. 1 and 2) may be pivotable (e.g., tilted) along a plurality of positions around a pivot axis 504 defined on the base. The pivot axis 504 may be located between a rear end of tilting head 502 and a portion of column 506 (e.g., relative to the transverse direction T). Thus, the pivot axis 504 may be a location that tilting head 502 and column 506 (e.g., including or provided as column 106—FIGS. 1 and 2) come into direct contact. In another embodiment, the pivot axis 504 is located on an additional intermediate support tab 508 that is coupled to tilting head 502 and column 506 separately such that the support tab 508 connects tilting head 502 and column 506. The support tab 508 may also pivot around the pivot axis 504 along with the tilting head 502 (e.g., during certain operations). The support tab 508 may be positioned at the top portion of the column 506, such that the support tab 508 engages with an internal bracket 602 and friction pin 604, as will be discussed in greater detail below. In one embodiment, the support tab 508 includes two symmetrical support tabs 508 positioned on opposite sides of the internal bracket 602.

The plurality of positions that the tilting head may pivot to may include a closed position 702. The closed position 702 may be associated with a locked tilting head 502, wherein a locked tilting head 502 is positioned along or proximate a horizontal plane (e.g., along the horizontal direction T—FIG. 1). For example, in the closed position 702, the tilting head 502 may be perpendicular to the column 506.

The plurality of positions may also include a first opened position 704. The first opened position 704 may be associated with a first preset angle, wherein the first preset angle describes the first opened position 704 with respect to the horizontal plane (e.g., along horizontal direction T). The first preset angle may be any angle between 0 degrees and 180 degrees, such as about 20 degrees to about 120 degrees, or such as about 30 degrees to about 70 degrees with respect to the horizontal plane. The first opened position 704 may also be associated with a certain height of a utensil attached to the tilting head 502, wherein the greater the degree of the first preset angle, the greater the height of the utensil.

The plurality of positions may further include a second opened position 706. The second opened position 706 may be associated with a second preset angle, wherein the second preset angle describes the second open position 706 with respect to the horizontal plane (e.g., along horizontal direction T). The second preset angle may be greater than the first preset angle. The second preset angle may be any angle between 0 degrees and 180 degrees, such as about 40 degrees to 160 degrees, such as about 60 degrees to about 120 degrees. The second opened position 706 may also be associated with a certain height of a utensil attached to the tilting head 502, wherein the greater the degree of the second preset angle, the greater the height of the utensil.

Tilting head 502 may include a button 402. The button 402 may be positioned on top of the tilting head 502. The button 402 may further be positioned proximal to a rear end of the tilting head 502. The term proximal, as used herein, may refer to a position associated with a certain portion of the tilting head 502 (e.g., a certain half, a certain quarter, etc. relative to the transverse direction T). Thus, the button 402 may be positioned on the same end (e.g., relative to the transverse direction T) as the pivot axis 504, such that the button 402 is positioned over or almost over the pivot axis 504. In one embodiment, the button 402 is a physical button such that the physical button has a freedom of movement in a vertical direction V. In another embodiment, the button 402 includes a static user interface element (e.g., capacitive touch pad) configured to transmit an electrical signal to a controller once a physical input is received (e.g., from a user’s touch or engagement). The button 402 may further be coupled to a button arm 404, such that the button arm 404 extends from the bottom of the button 402 through a casing 406 of the tilting head 502 and into a cavity within the tilting head 502. In one embodiment, the button 402 is fitted into a cut out portion of a casing 406 of the tilting head 502, such that the button 402 is flush with the casing 406 of the tilting head 502. In another embodiment, the button 402 is mounted on top of the casing 406 of the tilting head 502 and extends through the casing 406 of the tilting head 502, such that the button 402 is raised in comparison to the casing 406 of the tilting head 502.

The button 402 may also be coupled to a button spring 408 positioned within the tilting head 502. In one embodiment, the button spring 408 wraps around and extends down a portion of the button arm 404. In another embodiment, the button spring 408 is disposed or held in a cavity of the casing 406 of tilting head 502, such that the button spring 408 is positioned between the bottom of the button 402 and the cavity. Thus, the button spring 408 may be in biased engagement with the button 402. The button spring 408 may compress/extend between two states. In an elongated state, the button spring 408 may experience insufficient force to compress the button spring 408 further. In a shortened state, the button spring 408 may experience sufficient force to compress the button spring 408 from the elongated state. As will be discussed in greater detail below, the elongated state may be associated with an unpressed button 402, and the shortened state may be associated with a pressed button 402.

The stand mixer 100 may include a locking mechanism 300 positioned (e.g., at least in part) within the tilting head 502 and extending to the column 506. The locking mechanism 300 may include a linkage arm 302, a first rod 304, and a tiltable latch 306. Generally, and as will be described in greater detail below, the locking mechanism 300 may lock the tilting head 502 against the column 506 such that the tilting head 502 stays in the closed position 702. The locking mechanism 300 may also unlock the tilting head 502 from the column 506 such that the tilting head 502 may be pivotable around the pivot axis 504 (e.g., along a predetermined pivot range).

As previously mentioned, the locking mechanism 300 may include the linkage arm 302. The linkage arm 302 may extend from a first linkage end 308 of the linkage arm 302 to a tiltable latch 306 of the linkage arm 302. The first linkage end 308 may couple the locking mechanism 300 to the button 402. The linkage arm 302 may include a straight arm segment. The linkage arm 302 may also embody one or more different structures (e.g., an “S” or “L” shape) in order to efficiently couple the button 402 to the tiltable latch 306. The linkage arm 302 may further define a linkage pivot axis between the first linkage end 308 and the tiltable latch 306, wherein the linkage arm 302 is attached to a portion of the tilting head 502. The linkage arm 302 may attach to the portion of the tilting head 502 at approximately a halfway point of the linkage arm 302.

In one embodiment, the linkage arm 302 includes one or more linkage arms 302, such as two linkage arms 302. The two linkage arms 302 may be similar or the same (e.g., mirrored elements) and positioned on either side of the portion of the tilting head 502 that attaches to the linkage arms 302. The two linkage arms 302 may attach to the portion of the tilting head 502 via a static rod 310. Thus, the two linkage arms 302 may define the same linkage pivot axis. When assembled, the linkage arms 302 may be pivotable around the linkage pivot axis.

The locking mechanism 300 may further include the first rod 304. The first rod 304 may extend between the first linkage end 308 of the linkage arm 302 and the button arm 404 in order to couple the first linkage end 308 to the button 402. Thus, the button arm 404 may permit a force on the button 402 to be transferred to the linkage arms 302 through the first rod 304, as will be described in greater detail below. The first rod 304 may also be repositionable along the linkage pivot axis defined by the linkage arm 302. A first rod position (e.g., FIG. 3A) may be associated with a locked position, wherein the first rod 304 is at a raised position. A second first rod position (e.g., FIG. 3B) may be associated with an unlocked position, wherein the first rod 304 is at a lowered position, with respect to the first rod position. The first rod 304 may be pivotable between the first rod position and the second first rod position. In one embodiment, the first rod 304 extends between two linkage arms 302 in order to couple the two linkage arms 302 together, such that the two linkage arms 302 move in unison.

In some embodiments, the tiltable latch 306 is provided as a portion of the linkage arm 302, wherein the tiltable latch 306 may be in selective engagement with a catch surface 312 to hold the tilting head 502 in the closed position 702. Thus, the locking mechanism 300 may further contact the column 506 via the tiltable latch 306. The tiltable latch 306 may be provided as a hook-shaped end of the linkage arm 302, positioned on an opposite end of the linkage arm 302 as compared to the first linkage end 308, wherein the hook-shaped end engages with the catch surface 312. The catch surface 312 may also be provided as a cavity in the column 506 that receives the tiltable latch 306 and also restricts movement of the tiltable latch 306 in the upwards direction. The tiltable latch 306 may be movable between two positions. A first tiltable latch position (e.g., FIG. 3A) may be associated with the closed position 702. In the closed position 702, the tilting head 502 may be in a locked position and the tiltable latch 306 may contact the catch surface 312 defined on the column 506 while in the closed position 702.

A second tiltable latch position (e.g., FIG. 3B) may be associated with an unlocked position, wherein the tiltable latch 306 is disengaged from the catch surface 312 defined on the column 506. The tiltable latch 306 may disengage with the catch surface 312 by slightly translating toward a front end of the tilting head 502 and lifting (e.g., due to the pivot of the linkage arm 302). The tiltable latch 306 may reposition from the first tiltable latch position to the second tiltable latch position and momentarily be in a position between the first tiltable latch position and the second tiltable latch position. The reposition of the tiltable latch 306 from the first tiltable latch position to the second tiltable latch position may cause the tiltable latch 306 to lift vertically up, such that in the second tiltable latch position, the tiltable latch 306 is at a vertically greater height than at the first tiltable latch position. The tiltable latch 306 may lift up to a point where the tiltable latch 306 disengages with the column 506 while in the second tiltable latch position.

In one embodiment, the tiltable latch 306 includes one or more tiltable latches 306 such that the number of tiltable latches 306 matches the number of linkage arms 302 (e.g., each linkage arm 302 has a tiltable latch 306). Thus, two tiltable latches 306 may engage and disengage with the catch surface 312 as described above.

As noted above, the button 402 may be a physical button such that the physical button has a freedom of movement in a vertical direction V. Thus, a force applied to the button 402 may cause the button 402 to descend from a starting position (e.g., a user pressing the button 402 down). The force on the button 402 may drive the button arm 404 down such that the force on the button 402 transfers through the first rod 304 to the first linkage end 308 of the linkage arm 302. The force on the first linkage end 308 may cause the linkage arm 302 to pivot around the linkage pivot axis, such that the first linkage end 308 descends and the tiltable latch 306 disengages from the catch surface 312. Upon the tiltable latch 306 disengaging from the catch surface 312, the tilting head 502 may be unlocked from the column 506. Once the force is removed from the button 402, the button 402 may ascend back to the starting position (e.g., through the use of the button spring 408). The ascension of the button 402 may cause the linkage arm 302 to pivot back around the linkage pivot axis, such that the tiltable latch 306 re-engages with the catch surface 312 and the locking mechanism 300 resets. Upon the tilting head 502 re-engaging with the catch surface 312, the tilting head 502 may once again be locked to the column 506.

Separate from or in addition to the locking mechanism 300, the stand mixer 100 may include an opening mechanism for pivoting tilting head 502 from the closed position 702 (e.g., to the first opened position 704), such as when the tilting head 502 is unlocked. In some embodiments, the opening mechanism may be mounted within or provided as part of the column 506. For instance, the opening mechanism may be mounted within an inner cavity defined by the column 506. Generally, the opening mechanism includes an actuator shaft, a friction pin 604, and a guide track 606. The actuator shaft may be positioned within a portion of the column 506, such that the actuator shaft extends vertically between the base of the stand mixer 100 and the tilting head 502. The actuator shaft may engage with the intermediate support tab 508 that defines the pivot axis 504. In some embodiments, the actuator shaft includes a connector arm 510, spring 512, ring-shaped cap 514, and piston 516. As will be described in detail below, the opening mechanism can act to apply an upward force to the tilting head 502, such as to pivot the tilting head 502 to the first opened position 704.

The connector arm 510 may be provided as a singular component within the column 506 used to connect portions of the actuator shaft to the tilting head 502. In this way, other components (e.g., spring 512) in the column 506 may be utilized to pivot the tilting head 502. Notably, the stand mixer 100 may not need an external component or lifting by a user in order to apply an upwards force to the tilting head 502. The connector arm 510 may serve to connect the spring 512 to the friction pin 604. The connector arm 510 may be positioned between the base of the column 506 and the tilting head 502. Further, the connector arm 510 may be positioned vertically between the piston 516 and the friction pin 604, as will be described in greater detail below. The connector arm 510 may include a radial flange. The radial flange may be described as a portion of the connector arm 510 with an increased width (e.g., in a radial direction). The radial flange may also have a bottom-facing contact surface 410 and be positioned at any point of the connector arm 510 (e.g., such as proximal to a top portion of the connector arm 510). The connector arm 510 may also include a coupling component. The coupling component may be positioned at the top portion of the connector arm 510 (e.g., such as at a top end of the connector arm 510). The coupling component may include a cylindrical shaped connector arm cavity 412, such that the cylindrical shaped connector arm cavity 412 may receive the friction pin 604 and couple the connector arm 510 to the friction pin 604. The connector arm 510 may be repositionable vertically between a first position associated with a locked tilting head and a second position associated with an unlocked tilting head.

The spring 512 may be positioned between the piston 516 and the friction pin 604. In one embodiment, the spring 512 wraps around the connector arm 510 and contacts a top portion of the ring-shaped cap 514 and the bottom-facing contact surface 410 of the radial flange. The spring 512 may be extendable/compressible between two positions. A first spring position may be described as a shortened position, wherein the spring 512 is in contact with both the ring-shaped cap 514 and the bottom-facing contact surface 410 such that the spring 512 is compressed and exerting a force on the ring-shaped cap 514 and bottom-facing contact surface 410. The shortened position may be associated with a locked tilting head position. From the shortened position, the spring 512 may be extendable to an elongated position, as will be described in greater detail below. The elongated position may be described as a position at which the spring 512 extends to a point of equilibrium, in which forces acting on the spring 512 are insufficient to extend/compress the spring 512 anymore. The elongated position may be associated with an unlocked tilting head position (e.g., an “opened” tilting head). The spring 512 may be attached to the casing 406 in biased engagement with the tilting head 502 to bias the tilting head 502 to the first opened position 704 from the closed position 702. Furthermore, the bottom of the spring 512 may be physically coupled to the ring-shaped cap 514 or the top of the spring 512 may be physically coupled to the bottom-facing contact surface 410. In another embodiment, the spring 512 is not physically coupled to either the ring-shaped cap 514 or the bottom-facing contact surface 410 and instead rests between the ring-shaped cap 514 and the bottom-facing contact surface 410.

The piston 516 may be positioned between the base of the column 506 and the connector arm 510. In one embodiment the piston 516 rests directly beneath the connector arm 510. In another embodiment, the ring-shaped cap 514 is positioned on top of the piston 516 such that the ring-shaped cap 514 is positioned between the connector arm 510 and the piston 516, and the bottom of the connector arm 510 is positioned in a central aperture of the ring-shaped cap 514. In a first position, the piston 516 may be set in a lowered orientation associated with a closed tilting head. In a second position, the piston 516 may be set in a raised orientation associated with an opened tilting head. The piston 516 may reposition between the first position and the second position and may incorporate a resistive functionality, as will be described in detail below.

Thus, the actuator shaft may function as follows. When the tiling head 502 is in the closed position 702, the actuator shaft may be in a static position. The spring 512 may exert a force on the bottom-facing contact surface 410 of the connector arm 510, however due to the tiltable latch 306 holding the tilting head 502 against the column 506, the force may not cause the connector arm 510 to reposition. Upon the locking mechanism 300 unlocking the tilting head 502 from the column 506, the spring force may propel the connector arm 510 vertically upwards to a point where the spring 512 is in the elongated position. The connector arm 510 may, in response, push the tilting head 502 opened (e.g., via the friction pin 604), such that the tilting head 502 is pivoted to the first opened position 704. Similarly, upon the spring 512 extending and lifting the connector arm 510 from the piston 516, the piston 516 may reposition to the second position, wherein the piston 516 is in a raised orientation. As the connector arm 510 lifts vertically upwards, the connector arm 510 may also tilt slightly forward. This slight tilt may be in response to a pivot path of the tilting head 502, since the connector arm 510 is coupled to the tilting head 502 through the friction pin 604. Thus, the actuator shaft may act as a spring-loaded opening mechanism in order to pivot the tilting head 502 to the first opened position 704.

The friction pin 604 may be positioned at or around a pivot axis 504 of the tilting head 502. Thus, in one embodiment, the friction pin 604 is a part of the tilting head 502. In another embodiment, the friction pin 604 is part of the additional intermediate support tab 508 that is coupled to tilting head 502 and column 506 separately such that the support tab 508 connects the tilting head 502 and the column 506. The friction pin 604 may be provided as a smooth, rounded pin. As previously mentioned, the connector arm cavity 412 receives the friction pin 604, such that the friction pin 604 and connector arm 510 are coupled together. The friction pin 604 may extend through an entirety of the connector arm cavity 412. Thus, the movement of the connector arm 510 may influence the movement of the friction pin 604 and vice versa.

The friction pin 604 may further be received by a guide track 606 (e.g., one or more guide tracks 606, such as two symmetrical guide tracks 606, the friction pin 604 extending between the two symmetrical guide tracks 606). The guide track 606 may include or be provided as a cut-out portion of the column 506 (e.g., as a groove or cut out within which the friction pin 604 is received). In some embodiments, the column 506 includes an outer shell and an internal bracket 602 fixed relative to the outer shell. In such embodiments, the guide track 606 is defined by the internal bracket 602. The guide track 606 may be positioned proximal to the pivot axis 504 such that the pivot axis 504, friction pin 604, and the guide track 606 couple the column 506 and the tilting head 502 together. The guide track 606 may be provided as a smooth, rounded gap area. In one embodiment, the column 506 and tilting head 502 are coupled together (e.g., via the additional intermediate support tab 508, such that the friction pin 604 is part of the additional intermediate support tab 508 and the guide track 606 is defined by the column 506). The guide track 606 may be provided in a curved shape, such that the curve defines a portion of a pivot path of the tilting head 502. The guide track 606 may receive the friction pin 604 tightly, such that the width of the guide track 606 is approximately equal to the diameter of the friction pin 604. Due to the guide track 606 being provided as a cut out portion of the column 506, the guide track 606 may not reposition while the tilting head 502 pivots. Thus, the friction pin 604 may move along the guide track 606, therefore producing a significant friction force (e.g., due to the similarity in size between the friction pin 604 and the guide track 606).

While opening to the first opened position 704 (e.g., due to the force from the spring 512), the connector arm 510 may push the friction pin 604 through a portion of the guide track 606, in order to pivot the tilting head 502. Thus, the friction pin 604 may act to transfer the force of the spring 512 through the connector arm 510 and up to the tilting head 502 in order to force the tilting head 502 opened to the first opened position 704. During the opening to the first opened position 704, the friction pin 604 acts as a friction dampener in order to resist the force of the spring 512 and avoid an erratic pivoting of the tilting head 502 (e.g., “soft open”), as the friction pin 604 passes along the guide track 606. Thus, the friction force between the friction pin 604 and guide track 606 may act as a resistive force against the spring 512, such that the tilting head 502 pivots to the first opened position 704 smoothly. The first opened position 704, described as angle beta, may be associated with a first position of the friction pin 604, wherein the friction pin 604 and tilting head 502 rotate around the pivot axis 504 at a similar or same rate. After the spring 512 extends and the tilting head 502 pivots to the first opened position 704, the guide track 606 and friction pin 604 may also function to assist in holding the tilting head 502 steady at the first opened position 704 due to the friction between the friction pin 604 and guide track 606.

The stand mixer 100 may also permit pivoting the tilting head 502 from the first opened position 704 to the second opened position 706. Pivoting to the second opened position 706 may utilize the guide track 606 and the friction pin 604 (e.g., as previously discussed) and may be performed to pivot the tilting head 502 to the second opened position 706 after the tilting head 502 has been previously unlocked and pivoted to the first opened position 704. The tilting head 502 may also be pivotable to any position between the first opened position 704 (e.g., beta) and the second opened position 706 (e.g., phi). In one embodiment, due to the lack of coupling in the actuator shaft, pivoting to the second opened position 706 requires an external physical force (e.g., provided by user). Thus, any pivoting past the first opened position 704 may be physically enforced by a user (e.g., the user pivoting the tilting head 502 past the first opened position 704 with their hands).

Similarly to the pivoting from the closed position 702 to the first opened position 704, the pivoting from the first opened position 704 to the second opened position 706 may also push the friction pin 604 through the guide track 606. The friction pin 604 may be further moveable throughout the entirety of the guide track 606, such that when the friction pin 604 is positioned at a top end of the guide track 606, the tilting head 502 is considered to be maximally open. Furthermore, between the first opened position 704 and the second opened position 706, the tilting head 502 may be considered to be freely pivotable. Thus, the tilting head 502 and friction pin 604 are continuously variable between the first opened position 704 and the second opened position 706. If a strong enough force is applied to the friction pin 604, the friction pin 604 may slide through the guide track 606, however once that force is removed, the friction pin 604 may stay in place at the position that the friction pin 604 was last moved to. While in the guide track 606, the friction pin 604 may create a high enough friction force that the weight of the tilting head 502 does not cause the tilting head 502 to pivot back to the first opened position 704.

Furthermore, a multi-step tilting process of the stand mixer 100 in FIGS. 3A through 7 may function as follows. The multi-step tilting process may include a first step. The first step may be provided as a step for unlocking the tilting head 502 from the column 506. The tilting head 502 may be unlocked via the locking mechanism 300. An external force applied to the button 402 may cause the button 402 to descend from the button’s original starting position. The force may then transfer from the button 402 to the button arm 404. The button arm 404 descending may transfer the force through the first rod 304 to the linkage arms 302 as to cause the linkage arms 302 to pivot around the linkage pivot axis. The pivoting of the linkage arms 302 may then cause the tiltable latches 306 to lift up and disengage from the catch surface 312. Upon the tiltable latches 306 disengaging from the catch surface 312, the tilting head 502 may be considered to be unlocked. Once the external force is removed from the button 402, the button 402 may return to the unpressed position (e.g., due to the button spring 408) and the locking mechanism 300 as a whole may return to the previous position of the locking mechanism 300 before the button 402 was pressed.

The multi-step tilting process may also include a second step. The second step may be provided for pivoting the tilting head 502 to a first opened position 704. The first step may trigger or directly cause the second step to occur. The tilting head 502 may be pivoted to the first opened position 704 via an opening mechanism. Once the tiltable latches 306 disengage from the catch surface 312 and the tilting head 502 unlocks, the force exerted by the spring 512 on the bottom-facing contact surface 410 of the connector arm 510 may force the connector arm 510 upwards. The connector arm 510 moving upwards may then transfer force exerted by the spring 512 to the friction pin 604 due to the friction pin 604 being received by the connector arm cavity 412. The friction pin 604 may then be pushed upwards along the guide track 606 such that the tilting head 502 begins to pivot along with the friction pin 604. The friction between the friction pin 604 and guide track 606 may resist the force of the spring 512 such that the friction pin 604 moves slowly through the guide track 606 instead of erratically. Thus, the friction pin 604 may cause the tilting head 502 to open more softly than conventional spring-loaded apparatuses. Upon the tilting head 502 pivoting to the first opened position 704, the spring 512 may have extended to a point of equilibrium. The extension of the spring 512 may cause the connector arm 510 to reposition to a vertically elevated position due to the bottom-facing contact surface 410 of the connector arm 510 resting on the spring 512. The friction pin 604 may also move upwards along the guide track 606, such that the amount the friction pin 604 moves through the guide track 606 is associated with the amount that the tilting head 502 pivoted. Thus, a force (e.g., user pressing) on the button 402 may cause the locking mechanism 300 to unlock and the tilting head 502 to automatically pivot to the first opened position 704.

The multi-step tilting process may also include a third step. The third step may be provided for pivoting the tilting head 502 past the first opened position 704 to a second opened position 706. The third step may be independent of the first two steps such that an action done in the first step or second step will not directly cause the third step to occur. The third step may require a physical force from a user to pivot the tilting head 502 from the first opened position 704 to the second opened position 706. For example, the user may be required to physically lift the tilting head 502 up with their hands. In another embodiment, the pivoting of the tilting head 502 between the first opened position 704 and second opened position 706 may be controlled via a controller. The user may input a preferred angle (e.g., via a user interface of the stand mixer) which causes the controller to send an input to tilt the tiling head 502 to the preferred angle.

While the tilting head 502 is being lifted and pivoting past the first opened position 704, the friction pin 604 and guide track 606 may still resist the pivoting motion due to the friction force generated between the two. The guide track 606 may remain in contact with the friction pin 604 between the first opened position 704 and the second opened position 706 to apply resistance to the motion of the friction pin 604. Thus, the user may need to exert enough force to overpower the friction force.

Due to the friction pin 604 being a smooth, rounded pin and the guide track 606 also being a smooth cut out portion of the column 506, the tilting head 502 may be pivotable to any variable position between the first opened position 704 and the second opened position 706. Thus, the tilting head 502 position is continuously variable, notably without a restriction to certain interval positions between the first opened position 704 and second opened position 706. Upon the user pivoting the tilting head 502 to the preferred position, the friction pin 604 may hold the tilting head 502 at the preferred position due to the friction force created between the friction pin 604 and guide track 606. Notably, the constant contact of the friction pin 604 allows the exact position of the tilting head 502 to be maintained without any need for a user to engage the friction pin 604 in any way. Thus, the user does not have to manually hold the tilting head 502 at the preferred angle while also attempting to engage a holding pin. The second opened position 706 may be considered as a maximally opened position.

In order to return the tilting head 502 to the closed position 702, the user may be required to exert a downward force on the tilting head 502 such that the downward force is greater than the friction force of the friction pin 604 and the spring force. Upon the tilting head 502 pivoting back to the closed position 702, the friction pin 604 may return to a starting position at the bottom of the guide track 606 and the spring 512 may return to a compressed position. The piston 516 may act to receive the connector arm 510 as the connector arm 510 descends, such that the downward force of the connector arm 510 is lessened by the functionality of the piston 516. Once the tilting head 502 reaches the closed position 702, the tiltable latches 306 may automatically re-engage with the catch surface 312 such that the tilting head 502 becomes locked to the column 506 and the multi-step opening process may be repeated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer comprising:
a casing comprising a base and a column extending from the base along a vertical direction, the casing defining an interior surface directed toward an interior cavity and an exterior surface directed away from the interior cavity;
a tilting head positioned on top of the column, the tilting head being pivotable between a closed position and a first opened position, the tilting head further being pivotable between the first opened position and a second opened position, an angle of the second opened position relative to a horizontal direction being greater than an angle of the first opened position relative to the horizontal direction;
a spring attached to the casing in biased engagement with the tilting head to bias the tilting head to the first opened position from the closed position; and
a friction pin mounted on the column in selective friction engagement with the tilting head to hold the tilting head at a variable position between the first opened position and the second opened position.

2. The stand mixer of claim 1, wherein the friction pin is received within a guide track defined along a pivot path of the tiling head.

3. The stand mixer of claim 2, wherein the guide track remains in contact with the friction pin between the first opened position and the second opened position to apply resistance to a motion of the friction pin.

4. The stand mixer of claim 1, further comprising:
a button mounted to the tilting head;
a tiltable latch coupled to the button; and
a catch surface attached to the casing, the tiltable latch being in selective engagement with the catch surface to hold the tilting head in the closed position.

5. The stand mixer of claim 4, wherein the button is coupled to the tiltable latch via a linkage arm, the linkage arm extending from a first linkage end to the tiltable latch.

6. The stand mixer of claim 4, further comprising a button arm coupled to the button and extending vertically therefrom, wherein the button arm transfers a force on the button to the tiltable latch, the force causing the tiltable latch to disengage from the catch surface.

7. The stand mixer of claim 6, wherein the catch surface is defined within the column, such that a tiltable latch disengagement from the catch surface causes the spring to extend and bias the tilting head to the first opened position.

8. The stand mixer of claim 1, wherein the variable position is continuously variable between the first opened position and the second opened position.

9. The stand mixer of claim 1, wherein the friction pin is in resistive engagement with the spring to dampen an extension of the spring.

10. The stand mixer of claim 1, further comprising a piston positioned between the spring and a base of the column in order to lessen an impact caused by the tilting head closing.

11. A stand mixer comprising:
a casing comprising a base and a column extending from the base along a vertical direction, the casing defining an interior surface directed toward an interior cavity and an exterior surface directed away from the interior cavity;
a tilting head positioned on top of the column, the tilting head being pivotable between a closed position and a first opened position and between the first opened position and a second opened position, an angle of the second opened position relative to a horizontal direction being greater than an angle of the first opened position relative to the horizontal direction;
a spring attached to the casing in biased engagement with the tilting head to bias the tilting head to the first opened position from the closed position;
a friction pin mounted on the column in selective friction engagement with the tilting head to hold the tilting head at a variable position between the first opened position and the second opened position, wherein the friction pin is received within a guide track defined along a pivot path of the tiling head;
a button mounted to the tilting head;
a tiltable latch coupled to the button; and
a catch surface attached to the casing, the tiltable latch being in selective engagement with the catch surface to hold the tilting head in the closed position.

12. The stand mixer of claim 11, wherein the guide track remains in contact with the friction pin between the first opened position and the second opened position to apply resistance to a motion of the friction pin.

13. The stand mixer of claim 11, wherein the button is coupled to the tiltable latch via a linkage arm, the linkage arm extending from a first linkage end to the tiltable latch.

14. The stand mixer of claim 11, further comprising a button arm coupled to the button and extending vertically therefrom, wherein the button arm transfers a force on the button to the tiltable latch, the force causing the tiltable latch to disengage from the catch surface.

15. The stand mixer of claim 14, wherein the catch surface is defined within the column, such that a tiltable latch disengagement from the catch surface causes the spring to extend and bias the tilting head to the first opened position.

16. The stand mixer of claim 11, wherein the variable position is continuously variable between the first opened position and the second opened position.

17. The stand mixer of claim 11, wherein the friction pin is in resistive engagement with the spring to dampen an extension of the spring.

18. The stand mixer of claim 1, further comprising a piston positioned between the spring and a base of the column in order to lessen an impact caused by the tilting head closing.
